(19) United States
(12) Patent Application Publication
(10) Pub. No.: US 2025/0182254 A1
(43) Pub. Date: Jun. 5, 2025

(54) SYSTEM AND A METHOD FOR DENOISING AN IMAGE

(71) Applicant: SAMSUNG ELECTRONICS CO., LTD., Suwon-si (KR)

(72) Inventors: Sri Harsha Raja Koundinya Vutukuru, Bengaluru (IN); Gaurav Khandelwal, Bengaluru (IN); Kiran Nataraju, Bengaluru (IN); Nutan Sairam Yenneti, Bengaluru (IN); Sourabh Agrawal, Bengaluru (IN); Vighnesh Bhaskar Kamath, Bengaluru (IN); Narasimha Gopalakrishna Pai, Bengaluru (IN)

(73) Assignee: SAMSUNG ELECTRONICS CO., LTD., Suwon-si (KR)

(21) Appl. No.: 19/050,551

(22) Filed: Feb. 11, 2025

Related U.S. Application Data
(63) Continuation of application No. PCT/IB2024/060189, filed on Oct. 17, 2024.

(30) Foreign Application Priority Data
Oct. 17, 2023 (IN) 202341070527
Sep. 27, 2024 (IN) 202341070527

(51) Int. Cl. G06T 5/70; G06T 5/60

(52) U.S. Cl. CPC G06T 5/70; G06T 5/60; G06T 2207/20081; G06T 2207/20182; G06T 2207/20208; G06T 2207/20221

(57) ABSTRACT

Disclosed herein is a method for denoising an image. The method includes obtaining a MEV blended frame based on a plurality of input images, wherein each of the plurality of input images comprises an EV; receiving a plurality of parameters associated with each of the plurality of input images; obtaining a plurality of first hyper parameters associated with the plurality of parameters associated with each of the plurality of input images; identifying a tuning vector among a plurality of tuning vectors based on a distance between a plurality of second hyper parameters that are associated with each of the plurality of tuning vectors and the plurality of first hyper parameters; modifying weight(s) of a denoising AI model based on the tuning vector and the plurality of first hyper parameters using an encoder AI model; and denoising the MEV blended frame using the denoising AI model having the modified weight(s).

### CROSS-REFERENCE TO RELATED APPLICATION

This application is a bypass continuation of an International application No. PCT/IB2024/060189, filed on Oct. 17, 2024, which is based on and claims the benefit of an Indian Provisional Specification patent application number No. 202341070527, filed on Oct. 17, 2023, in the Indian Intellectual Property Office, and of an Indian Complete Specification patent application number No. 202341070527, filed on Sep. 27, 2024, in the Indian Intellectual Property Office, the disclosure of each of which is incorporated by reference herein in its entirety.

### TECHNICAL FIELD

The present disclosure relates to image processing and more particularly, relates to a system and a method for an Artificial Intelligence (AI)-driven denoising of images.

### BACKGROUND

Smartphone photography allows users to capture images in greater detail. Smartphones generally employ multiple image sensors having different Fields Of View (FOV). In addition, smartphones use various Artificial Intelligence (AI) models to post-process the captured images to remove defects in the captured images. One of the defects is random variation in brightness and color level in some portions of images, which is commonly known as noise. Noise is generally seen as grains in the images and tends to reduce the sharpness of the captured images. The degree and location of the noise are generally associated with different types of sensors associated optics. Therefore, in related art separate AI denoising models are needed to denoise the captured image for each sensor type.

One of the limitations of the above-mentioned approach of related art is that running multiple AI denoising models means longer times to process the images. One of the ways to mitigate this issue is to train a single large denoising AI model for all the sensor types. However, a large denoising AI model is resource-intensive. Further, the effectiveness of both multiple small AI denoising models and the single large denoising AI model is limited by the resources of the smartphone. In addition, the AI denoising models also suffer from artefacts (green tinges, noise, blur) in the image, where due to dynamic range and variation in noise characteristics, green tinge artefacts are formed by the AI denoising model.

Therefore, in view of the above-mentioned problems, it is advantageous to provide an improved system and method that can overcome the above-mentioned problems and limitations associated with the existing denoising techniques.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an embodiment of the present disclosure, a controlling method of an electronic apparatus for denoising an image is provided. The method may be executed by at least one processor, and the method includes: obtaining a Multi-Exposure Value (MEV) blended frame based on a plurality of input images, wherein each of the plurality of input images comprises an Exposure Value (EV); receiving a plurality of parameters associated with each of the plurality of input images; obtaining (or identifying or generating) a plurality of first hyper parameters associated with the plurality of parameters associated with each of the plurality of input images; identifying a tuning vector among a plurality of tuning vectors based on a distance between a plurality of second hyper parameters that are associated with each of the plurality of tuning vectors and the plurality of first hyper parameters; modifying at least one weight of a denoising Artificial Intelligence (AI) model based on the tuning vector and the plurality of first hyper parameters using an encoder AI model; and denoising the MEV blended frame using the denoising AI model having the at least one modified weight.

According to an embodiment, an electronic apparatus for denoising an image is provided. The electronic apparatus may include a memory and at least one processor in communication with the memory. The at least one processor is configured to: obtain a Multi-Exposure Value (MEV) blended frame based on a plurality of input images, wherein each of the plurality of input images comprises an Exposure Value (EV), receive a plurality of parameters associated with each of the plurality of input images, obtain a plurality of first hyper parameters associated with the plurality of parameters associated with each of the plurality of input images, identify a tuning vector among a plurality of tuning vectors based on a distance between the plurality of first hyper parameters and a plurality of second hyper parameters that are associated with each of the plurality of tuning vectors, modify at least one weight of a denoising Artificial Intelligence (AI) model based on the tuning vector and the plurality of first hyper parameters using an encoder AI model, and denoise the MEV blended frame using the denoising AI model having the at least one modified weight.

According to an embodiment, a non-transitory computer readable medium storing one or more instructions is provided. The one or more instructions, when executed by at least one processor, cause the at least on processor to: obtain a Multi-Exposure Value (MEV) blended frame based on a plurality of input images, wherein each of the plurality of input images comprises an Exposure Value (EV); receive a plurality of parameters associated with each of the plurality of input images; obtain a plurality of first hyper parameters associated with the plurality of parameters associated with each of the plurality of input images; identify a tuning vector among a plurality of tuning vectors based on a distance between a plurality of second hyper parameters that are associated with each of the plurality of tuning vectors and the plurality of first hyper parameters; modify at least one weight of a denoising Artificial Intelligence (AI) model based on the tuning vector and the plurality of first hyper parameters using an encoder AI model; and denoise the MEV blended frame using the denoising AI model having the at least one modified weight.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a schematic block diagram of a user equipment having a system for optimizing a neural network model, in accordance with an embodiment of the present disclosure;

FIG. 2 illustrates a detailed schematic block diagram of the system, in accordance with an embodiment of the present disclosure;

FIG. 3 illustrates a flow chart of a method for denoising an image frame by modifying AI denoising weights, in accordance with an embodiment of the present disclosure; and

FIG. 4 illustrates a flow chart of a method for denoising the image frame by processing residual matrices, in accordance with an embodiment of the present disclosure;

FIG. 5 illustrates an overall sequence flow for capturing and processing an image, in accordance with an embodiment of the present disclosure;

FIG. 6 illustrates an overall sequence flow for the AI denoising model, in accordance with an embodiment of the present disclosure;

FIG. 7 illustrates a sequence flow for denoising an image using the denoising AI model based on residual matrices, in accordance with an embodiment of the present disclosure;

FIG. 8 illustrates exemplary residual matrices for processing by the AI denoising model, in accordance with an embodiment of the present disclosure;

FIG. 9 illustrates a sequence flow for denoising the image using the denoising AI model based on tuning vectors, in accordance with an embodiment of the present disclosure;

FIG. 10 illustrates a training process flow for training the denoising AI model with the tuning vectors, in accordance with an embodiment of the present disclosure; and

FIG. 11 illustrates exemplary image frames before and after the denoising, in accordance with an embodiment of the present disclosure.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

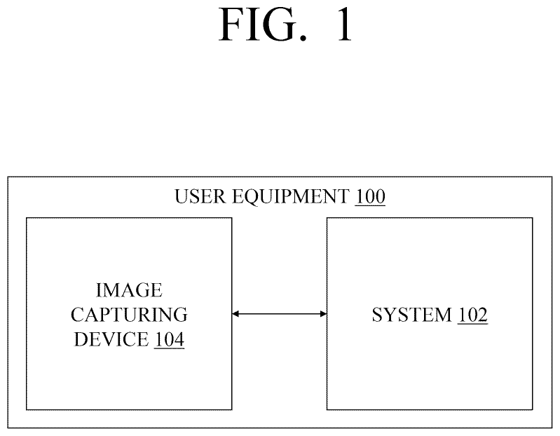

FIG. 1 illustrates a schematic block diagram of a User Equipment (UE) 100 having a system 102 for optimizing a neural network model, in accordance with an embodiment of the present disclosure. The UE 100 may be used by a user to capture images in the form of image frames and process the captured image frames. The image frames may be described as an image(s) or a frame(s). In one embodiment, the processing of the image frames may include, but not limited to, identifying and removing noise and other associated artefacts from the image. In one example, the UE 100 may be a smartphone. In another example, the user equipment 100 may be a digital camera, such as a Digital Single-Lens Reflex (DSLR) camera capable of capturing and processing the captured images. The UE 100 may include the system 102 and an image-capturing device 104. The image-capturing device 104 may include a single camera sensor or multiple camera sensors. The multiple camera sensors can be wide-angle sensor, ultra-wide-angle sensors, telephoto sensors, and macro lens sensors. Further, each of the aforementioned sensors may have associated optics, such as a number of lenses and prisms. The presence of such hardware components allows the capturing of images of an object/scene at different configurations, details of which will be provided in the following description.

In one example, the image-capturing device 104 is capable of capturing a plurality of images, such that the captured images may have different Exposure Values (EV). The EV may correspond to a number that represents a combination of a shutter speed and light-gathering ability of the optics of the image capturing device 104. The EV depicts an amount of light falling on an image sensor and is directly proportional to an aperture size of the image-capturing device 104. The EV may also be understood as a number on a scale that represents scene luminance, which is an amount of environmental light falling on the object (such as a person, place, or thing) in the scene. Further, each captured image may have a specific EV that may be represented by a corresponding nomenclature EV-4, EV-3, EV-3 . . . EV0, EV1 . . . EV4, such that a negative integer value represents a lower EV and a positive integer value represents a high EV. The image-capturing device 104 may capture a plurality of image frames of different EVs to allow the system 102 to process the image frames and determine information on the brightness of different regions of the image frames.

In an exemplary embodiment, the system 102 may be configured to denoise the image frame captured by the image-capturing device 104. The system 102 may be configured in such a way that the system 102 can denoise the image frame captured by multiple sensors in a shorter time and without overburdening other processing resource of the UE 100. The system 102 may be configured to effectively remove noise from the captured image frames having High Dynamic Range (HDR), i.e., an image frame with a very high ratio of brightest and darkest pixels of the image frame and great level of in variation of the brightness to darkness ratio across the image frame. The system 102 may employ an denoising AI model to denoise the image frame.

The system 102 may effectively and efficiently denoise the image frame in a plurality of different modes. In a first mode, the system 102 may determine information (such as coordinates, EV, motion blur, etc.) of individual pixels of the captured image frame, such that the denoising AI model processes individual pixels efficiently. In a second mode, the system 102 may modify the weights of the denoising AI model (also referred to as the AI denoising weights) using tuning vectors. In a third mode, the system 102 may implement both the modified AI denoising weights and pixel information to efficiently denoise the captured image frame. A detailed structure of the system 102 and an operation thereof is explained in forthcoming paragraphs.

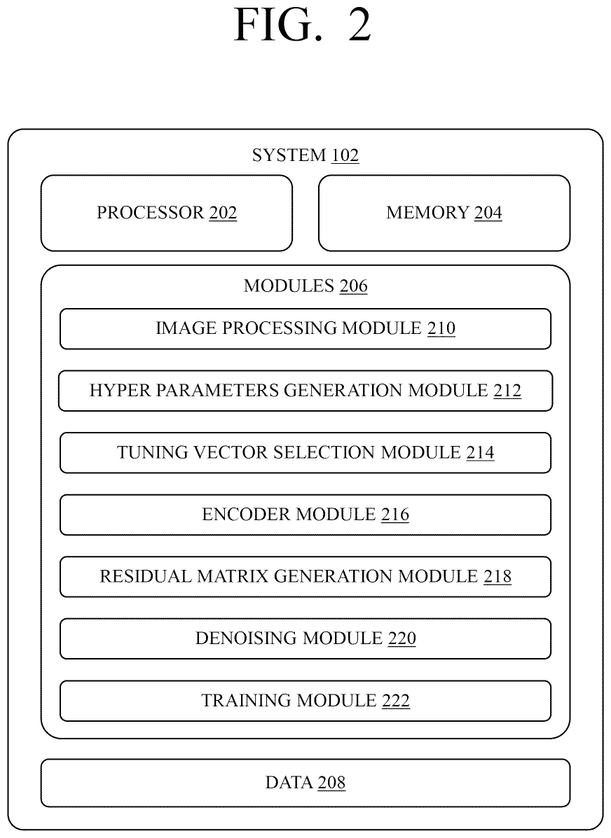

FIG. 2 illustrates a detailed schematic block diagram of the system 102, in accordance with an embodiment of the present disclosure. The system 102 may include different components that operate alone or in combination to denoise a Multi Exposure Value (MEV) blended frame. For instance, the system 102 may include a processor 202, a memory 204, module(s) 206, and data 208. The memory 204, in one example, may store the instructions to carry out the operations of the modules 206. The modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processor, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory 204, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The module(s) 206, amongst other things, includes routines, programs, objects, components, data structures, etc., which perform particular tasks or implement data types. The modules 206 may also be implemented as, signal processor 202(s), state machine(s), logic circuitries, and/or any other device or component that manipulated signals based on operational instructions.

Further, the modules 206 can be implemented in hardware, instructions executed by a processing unit, or by a combination thereof. The processing unit can comprise a computer, a processor, such as the processor 202, a state machine, a logic array, or any other suitable devices capable of processing instructions. The processing unit can be a general-purpose processor 202 which executes instructions to cause the general-purpose processor 202 to perform the required tasks or, the processing unit can be dedicated to performing the required functions. In another embodiment of the present disclosure, the modules 206 may be machine-readable instructions (software) which, when executed by a processor 202/processing unit, perform any of the described functionalities. Further, the data serves, amongst other things, as a repository for storing data processed, received, and generated by one or more of the modules 206. The data 208 may include information and/or instructions to perform activities by the processor 202.

The module(s) 206 may perform different functionalities which may include, but may not be limited to, receiving information and denoising the image frame. Accordingly, the module(s) 206 may include an image processing module 210, a hyper parameter generation module 212, a tuning vector selection module 214, an AI encoder module 216, a denoising module 218, a residual matrix generation module 220, and a training module 222. In one example, the at least one processor 202 may configured to perform the operation by actuating the aforementioned module(s) 206.

In one example, the image processing module 210 may be adapted to process a plurality of image frames for the plurality of captured image frames. The plurality of captured input images may include a plurality of input images that have a non-zero EV collectively called as non-EV bracketed frames and one or more input image with a zero-EV collectively called as an EV0 bracketed frame. The image processing module 210 may process the received input images, both the non-EV bracketed frames and the at least one EV0 frame to obtain a Multi-Exposure Value (MEV) blended frame. Multi-Exposure Value (MEV) is a technique that combines a plurality of image frames captured under different exposure conditions (such as brightness, shutter speed, and ISO) to generate the MEV blended frame. The MEV blended frame is a single optimized image (or a single combined image). This technique allows for clearer representation of both dark and bright areas in an image, effectively expanding the dynamic range. MEV is commonly used in cameras, smartphones' HDR (High Dynamic Range) functions, and video processing technologies to ensure details are visible even in high-contrast environments. According to an embodiment, the image processing module 210 may first blend the at least one EV0 bracketed frame to create a reference frame and thereafter blend the plurality of non-EV bracketed frames and other reference frames using a known image processing technique.

In one example, the hyper parameter generation module 212 may receive a plurality of parameters associated with each of the plurality of input images from the image-capturing device 104. For instance, the parameters may include, but are limited to, a brightness value of the ambient environment, lens parameters, types of the camera sensor, an International Organization of Standards (ISO) number, white balance values, a color correction matrix, sensor gain, and zoom ratio, among other examples. In one example, the image processing module 210 may generate a first hyper parameter based on the received plurality of parameters. The hyper parameter, in one example, may be a string of the values that may be generated by combining the parameters of the plurality of image frames.

Accordingly, the image processing module 210 may output an MEV blended frame and the hyper parameter generation module 212 may output the first hyper parameter that can be processed for subsequent analysis. A person of skill in the art will understand that the hyper parameter generation module 212 may output more than one hyperparameter.

In one example, the tuning vector selection module 214 may be configured to select a tuning vector from a set of tuning vectors. The tuning vector may be a floating-point number which may be indicative of modification that may be made of one or more weights of the denoising AI model to denoise the image frame effectively. The tuning vector may be associated with a type of second hyper parameters, such that the tuning vector may be selected based on the second hyper parameter generated by the hyper parameter generation module 210. For instance, the hyper parameters (either first or second) can be an ISO value, sensor type, among other examples. Generally, a location and a degree of noise in the image frame are dependent on the parameters of the image-capturing device. For instance, an image having an ISO parameter as 100 may have an associated trait of noise which will be distinct from the noise in the image having the ISO parameter as 1000. Therefore, selecting the tuning vector for the generated first hyper parameter associated with a defined parameter allows the system 102 to fine-tune the AI denoising model (also referred to as denoising AI model).

In one or more embodiments, the set of tuning vectors is obtained from a pre-trained first AI model. Such an approach has two-fold benefits. Firstly, the first AI model can be trained separately and may be used to train the AI denoising model. Secondly, the set of tuning vectors can be further improved by performing subsequent training of the first AI model and an output of the subsequent trained first AI model can be used directly to modify the weights of the denoising AI model without performing subsequent training on the AI denoising model. An exemplary manner in which the first AI model is trained is explained later.

In one example, the tuning vector selection module 214 may select the tuning vector and concatenate the second hyper parameter with the selected tuning vector to form a concatenated string. The concatenated string may be used by the AI encoder module 216 and may be adapted to receive the concatenated string and the weights of the AI denoising model. The AI encoder module 216 may operate an AI encoder to process the AI denoising weights of the denoising AI model using the concatenated string to modify the modified AI denoising weights. In one example, the AI encoder module 216, may modify a single or multiple modified AI denoising weights. In a same or another example, the AI encoder module 216 may modify all the AI denoising weights. The decision on the number of weights to be modified may be based on the type of second hyper parameter.

The residual matrix generation module 220 may be adapted to generate residual matrices using the MEV blended frame. The residual matrices may include information about individual pixels of the MEV blended frame. The information may include, but is not limited to, the EV of each pixel and the corresponding coordinates of each pixel with respect to a point of focus MEV blended frame. The information about individual pixels allows the denoising AI model to process individual pixels based on their respective EV and the location. For instance, pixels that are far from the point of focus may require a greater degree of denoising compared to pixels that are nearer to the point of focus. As another example, the pixels with lower EV are likely to have greater noise and therefore require greater processing. In other words, information (EV and corresponding coordinates) enables granularity in the AI denoising process which was not possible in the currently known denoising techniques.

In one example, the denoising module 218 may be adapted to denoise the MEV blended frame. The denoising module 218 may implement the denoising AI model to denoise the MEV blended frame. The denoising module 218 may denoise the blended MEV frame by taking inputs from either or both the residual matrix generation module 220 and the AI encoder module 216 depending upon the mode of the denoising module 218. The denoising module 218, in the first mode, may interact with the residual matrix generation module 220 to denoise the blended MEV frame based on the residual matrices. In an embodiment, the denoising module 218, in the second mode, may interact with the AI encoder module 216 to denoise the blended MEV frame based on the modified AI denoising weights. In an embodiment, in the third mode, the denoising module 218 may interact with the residual matrix generation module 220 to receive the residual matrices and with the AI encoder module 216 to receive the modified AI denoising weights. Further, the denoising module 218 may denoise the blended MEV frame based on both the residual matrices and modified AI denoising weights using the AI denoising model.

The training module 222 may be configured to train the AI denoising model. In one example, depending upon the modes, the denoising AI model can be trained by the training module 222. An exemplary manner of training the denoising AI model using the training module 222 is explained later.

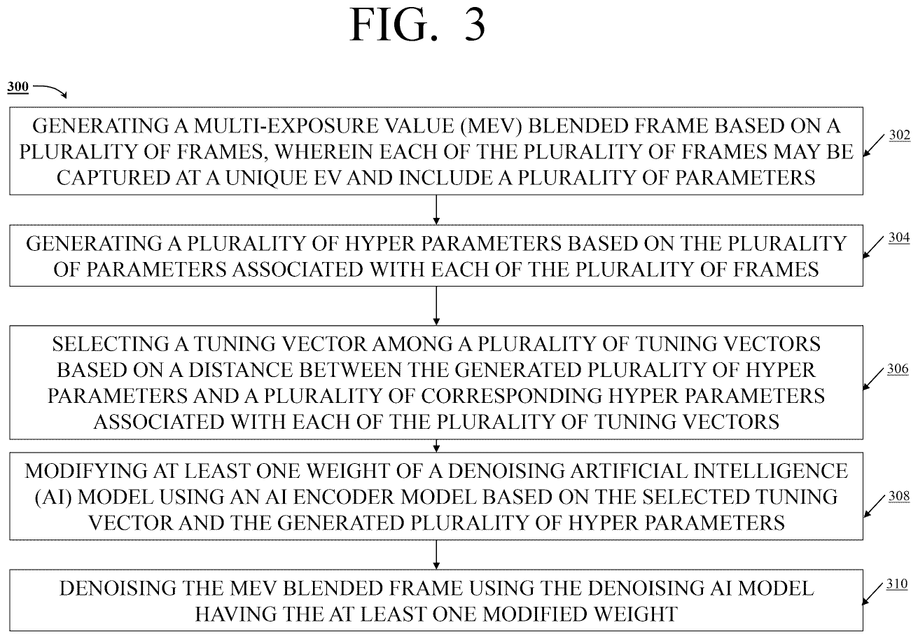

The present disclosure also relates to a method 300, illustrated in FIG. 3. Specifically, FIG. 3 illustrates a flow chart of the method 300 for denoising an image frame by modifying AI denoising weights, in accordance with an embodiment of the present disclosure. The order in which the method steps are described below is not intended to be construed as a limitation, and any number of the described method steps can be combined in any appropriate order to execute the method or an alternative method. Additionally, individual steps may be deleted from the method without departing from the spirit and scope of the subject matter described herein.

The method 300 can be performed by programmed computing devices, for example, based on instructions retrieved from non-transitory computer readable media. The computer readable media can include machine-executable or computer-executable instructions to perform all or portions of the described method. The computer readable media may be, for example, digital memories, magnetic storage media, such as magnetic disks and magnetic tapes, hard drives, or optically readable data storage media.

In one example, the method 300 may be performed partially or completely by the system 102 shown in FIG. 2.

In an embodiment, the method 300, at operation 302, the Multi-Exposure Value (MEV) blended frame is generated based on a plurality of input images. Further, each of the plurality of input images may be captured at a unique EV and includes a plurality of parameters.

Once the MEV blended frame is generated, at operation 304, a plurality of second hyper parameters is generated based on a plurality of parameters associated with each of the plurality of input images.

Further, at operation 306, a tuning vector among a plurality of tuning vectors is selected. The selection of the tuning vector is based on a distance between the plurality of first hyper parameters and a plurality of second hyper parameters associated with each of the plurality of tuning vectors.

At operation 308, at least one weight of the denoising Artificial Intelligence (AI) model is modified using the encoder AI model based on the selected tuning vector and the generated plurality of first hyper parameters.

Finally, at operation 310, the MEV blended frame is denoised using the denoising AI model having the at least one modified weight.

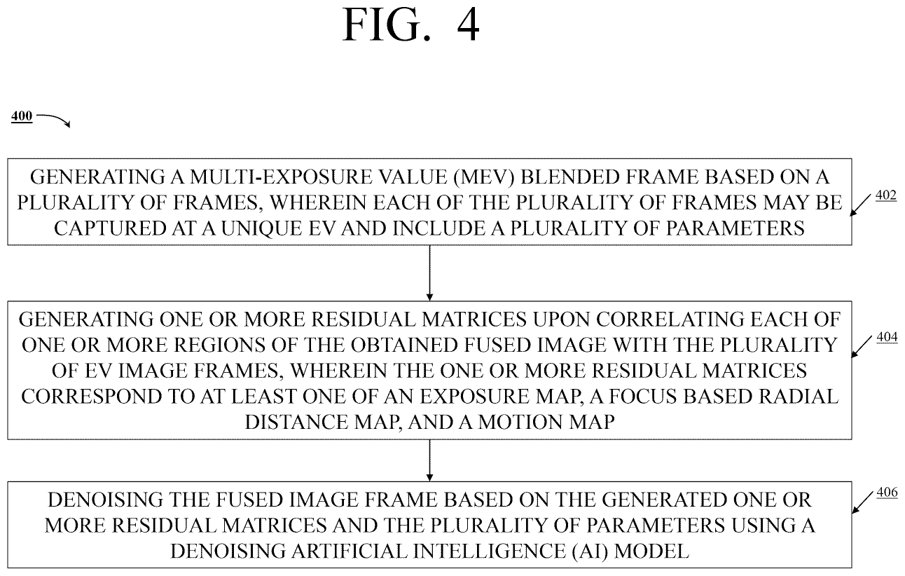

The present disclosure also relates to a method 400, illustrated in FIG. 4. Specifically, FIG. 4 illustrates a flow chart of a method for denoising the image frame by processing residual matrices, in accordance with an embodiment of the present disclosure. In one example, the method 302 may be performed partially or completely by the system 102 shown in FIG. 2.

At operation 402, the Multi-Exposure Value (MEV) blended frame is generated based on a plurality of input images. Further, each of the plurality of input images may be captured at a unique EV and includes a plurality of parameters.

Once the MEV blended frame is generated, at operation 404, one or more residual matrices are generated by correlating each of one or more regions of the obtained fused image with the plurality of EV images frames. Further, the one or more residual matrices correspond to at least one of an exposure map, a focus-based radial distance map (or radial distance map), and a motion map.

The one or more residual matrices may include at least one of an exposure map, a focus-based radial distance map (or radial distance map) or a motion map. The map may describe as matrix.

Finally, at operation 406, the blended MEV frame is denoised based on the generated one or more residual matrices and the plurality of parameters using a denoising Artificial Intelligence (AI) model.

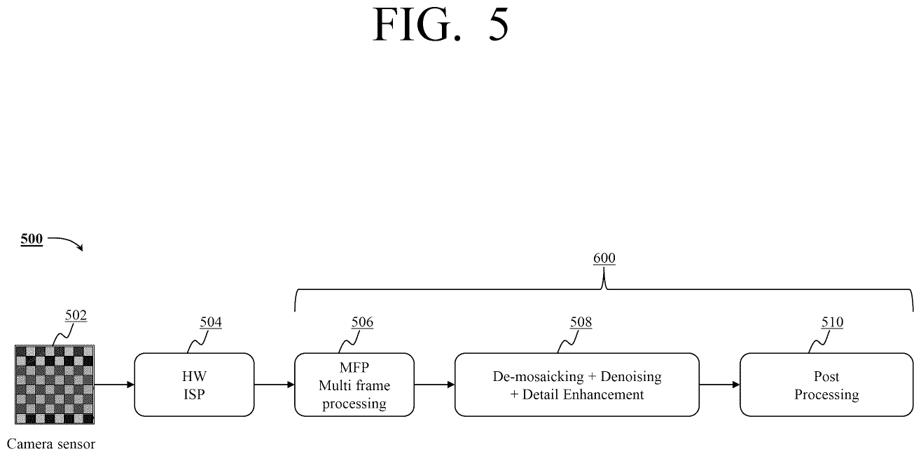

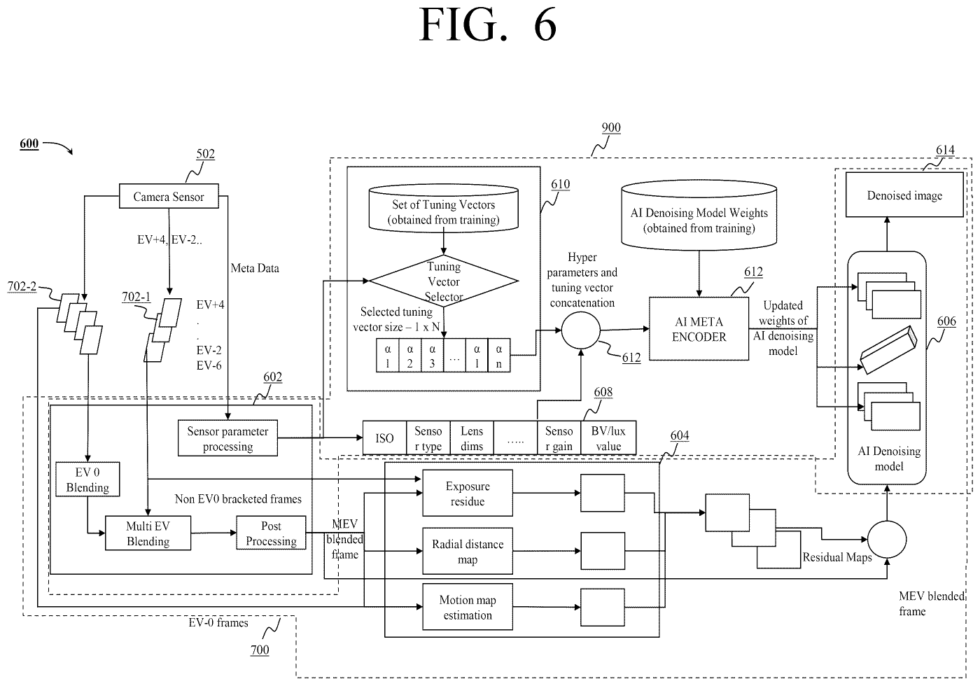

A detailed explanation of the aforementioned methods 300 and 400 are explained with respect to FIGS. 5 and 6.

FIG. 5 illustrates an overall sequence flow 500 for capturing and processing an image, in accordance with an embodiment of the present disclosure. The sequence flow 500 begins with the capturing of the images captured by a camera sensor at block 502. Thereafter, at block 504, the processor 202 may apply Hardware level Image Signal Processing (HW-ISP). The HW-ISP may include the application of any known techniques, such as Pixel Level Correction technique, White Balancing (WB) technique, and/or Lens Shade Correction (LSC) technique to correct inconsistencies that are introduced because of the type/size of the camera sensor and optics. At block 506, the multi frame processing is performed to provide MEV blended frame, details of which will be provided later. Further, at block 508, the processor 202 may process the MEV blended frame. The processing at block 508 may include, De-Mosaicking, Denoising, and Detail Enhancement. Finally, at block 510, the denoised blended MEV frame is post processed by applying known techniques, such as Color correction, Pixel Color Correction (PCC), and/or Gamma Dithering. Details of the blocks 506, 508, and 510 are also included as process flow 600 which is explained with respect to FIG. 6.

FIG. 6 illustrates an overall sequence flow 600 for the AI denoising model, in accordance with an embodiment of the present disclosure. According to the present disclosure, depending upon the configuration of the UE 100, the system 102 may either implement the blocks marked by a first sequence flow 600 for the first mode, a second sequence flow 800 for the second mode, or all the blocks in the third mode. The first sequence flow 700 may include blocks 602, 604, 606, and 614 whereas the second sequence flow 900 may include blocks 602, 608, 610, 612, 606, and 614. The details of each process flow for the first mode and the second mode are explained in detail in subsequent embodiments.

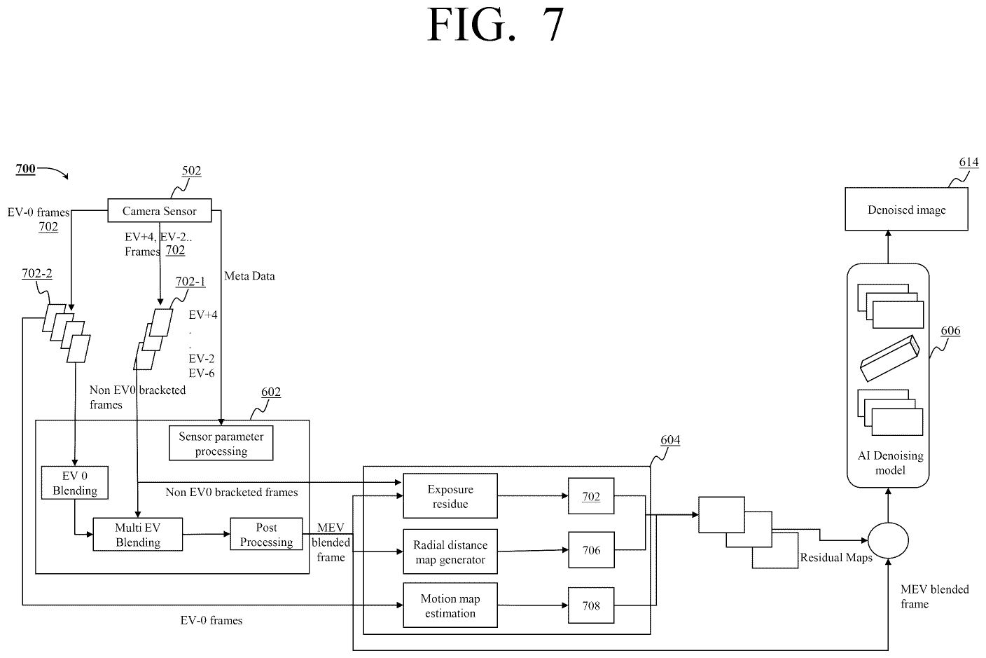

FIG. 7 illustrates a sequence flow 700 for denoising the image using the denoising AI model based on residual matrices, in accordance with an embodiment of the present disclosure. Initially, the at least one processor 202 may receive the plurality of image frames 702 from the image-capturing device 104. The captured images may include non-EV0 bracketed frames 702-1 and one or more EV0 frames 702-2. As may be understood, the range of EV values might vary according to the scene, and sensor type in the image-capturing device. In addition, the width and the height of each frame 702 are received. Although not visible, the sensors in the image-capturing device may include a metadata generator that may generate and provide the parameters associated with each image frame. The parameters may include, but are not limited to, a brightness value, lens parameters, a sensor type, and an ISO.

The aforementioned image frames 702 are received by the image processing module 210 at block 602 and the image processing module 210 may process the received image frames 702. For instance, the image processing module 210 may blend the EV0 frames 702-2 through simple averaging to generate a reference frame. The purpose of blending is to remove any temporal noise. The temporal noise are random variations in brightness of one or more pixels that appear in sequences of EV0 frames 702-2 taken over time. In another embodiment, the image processing module 210 may employ known blending techniques, such as alpha blending, pyramid blending, and layer masking, among other examples.

In addition, the image processing module 210 may further blend the reference frame with the non-EV0 bracketed frame 702-1 to generate the MEV blended frame. In order to blend the reference frame with the non-EV0 bracketed frame 702-1, the image processing module 210 may first generate a weight map using the reference frame and the EV value of the reference frame.

According to an example, the image processing module 210 may assign the notation ‘F’ to the non-EV0 bracketed frames 702-1 frames and their corresponding EV may be represented as ‘EV’. Further, the image processing module 210, assigns a notation ‘i’, to a given image frame and ‘R’ to the reference frame. Further, the weight map that is generated will be Wᵢ=f(R, EVᵢ)

The weight map is then used for a weighted average of the non-EV0 bracketed frames 702-1 along with the reference frame to get a MEV blended frame.

$$The MEV blended frame may be determined by = \frac{\sum {W}_{i} {F}_{i}}{\sum {W}_{i}} .$$

The MEV blended frame may include regions from all the EVs according to the scene. This technique is used to generate an HDR (High dynamic range) frame, which in this example, is the MEV blended frame.

The image processing module 210 may also perform post-processing on the MEV blended frame. As part of the post-processing, the image processing module 210 may perform Tone mapping, and gamma dithering to improve contrast and color representation of the MEV blended frame. In one example, the MEV blended frame may be termed as a fused image. The fused image may either be processed directly at block 604 in the first mode or directly at block 610 in the second mode.

At block 604, the residual matrix generation module 220 may process the fused frame (blended MEV frame) to generate one or more residual matrices. The residual matrices may provide information about the non-uniformity in the statistics of the image. Different EV image frames 702-1, 702-2 of the same scene may have different noise distributions (relative proportion of magnitude of Gaussian noise, Poisson noise, speckle noise etc. will vary and thus the standard deviation of noise), affecting the noise level characteristics (standard deviation vs pixel intensity graph) in different regions of the fused image frames. Further, this difference when blended to create the MEV blended frame creates non-uniformity in the statistics of the image. The residual matrix generation module 220 may capture information about variations in image noise caused by factors such as exposure value (EV) and pre-processing steps like lens shading correction.

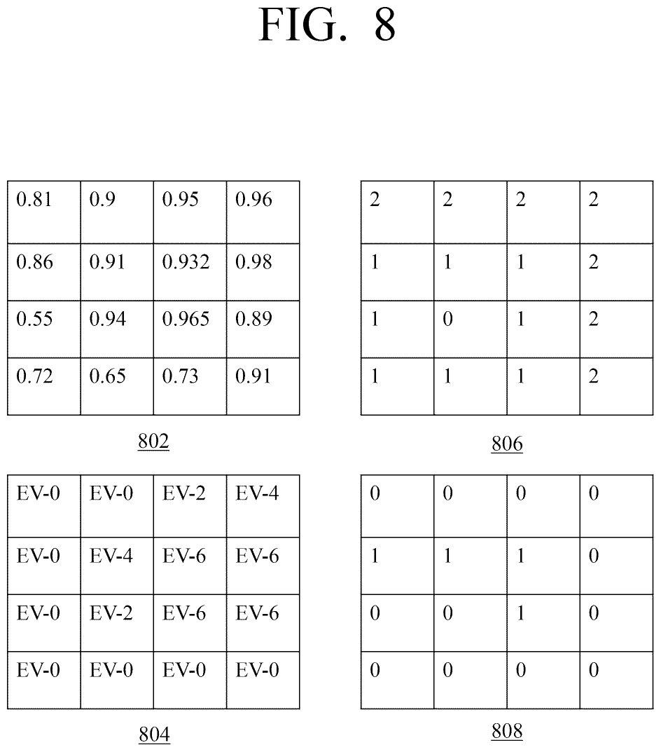

The residual matrices may include one or more 2-dimensional arrays of encoded information. Exemplary matrices are shown in FIG. 7. Specifically, FIG. 8 illustrates example residual matrices for processing by the AI denoising model, in accordance with an embodiment of the present disclosure. One of the residual matrices is noise distribution matrix 802 in which each cell represents a pixel and includes information about the presence of noise in each pixel. The residual matrix generation module 220 may normalize the noise distribution in the noise distribution matrix 802 by assigning values between 0 and 1, such the value 0 indicates zero noise and 1 indicates the greatest degree of noise. In one example, the residual matrix generation module 220 may first calculate a difference function, for each pixel, between the Fused frame and individual non-EV0 bracketed frames 602-1. Thereafter, the residual matrix generation module 220 may generate multiple difference frames representing the residual from each non-EV0 bracketed frame 602-1.

In addition, the residual matrix generation module 220 may generate an exposure matrix 804 that includes encoded information about the EV of each pixel of the fused frame. In one example, the residual matrix generation module 220 may use the EV of each pixel in the non-EV bracketed frames 602-1 as inputs and may encode the same using quantized floating numbers. For example, EV-6 can be represented as 0, EV-4 as 0.1, Ev-2 as 0.2 and so on.

Further, the residual matrix generation module 220 may generate a radial distance matrix (or radial distance map) 806. The residual matrix generation module 220 may generate the radial distance by identifying the pixel that has the point of focus. Thereafter, the residual matrix generation module 220 may determine the distance of each pixel relative to the point of focus. In one example, the residual matrix generation module 220 may determine the distance using Cartesian coordinates of the point of focus and the pixel for which the distance is calculated. This process is performed for each pixel and the residual matrix generation module 220 may encode the distance as a floating number. For instance, the pixel having the point of focus is assigned ‘0’ and other pixels are assigned ‘1’ and ‘2’ in the increasing order of their relative distance.

The residual matrix generation module 220 may also generate a motion map matrix. The motion matrix (or motion map) 808 represents the information about the change in pixel brightness caused by the motion of the object in the scene during the capturing of the image frames by the image-capturing device 104 (shown in FIG. 1). Such information is needed so that the denoising AI model can apply additional analysis on pixels that may have blurriness in addition to noise caused by the motion of the object. The residual matrix generation module 220 may compare the pixels of the reference frame and each of the non-EV0 bracketed frames 602-1 to determine if a pixel has blurriness. Accordingly, the residual matrix generation module 220 may encode the determined blurriness by assigning ‘1’ for pixel that includes blurriness and ‘0’ for pixels that do not include blurriness.

Referring back to FIG. 6, the residual matrix generation module 220 may provide the residual matrices to the denoising AI model at block 606. The denoising AI model can be a Convolutional Neural Network (CNN) model deployable on the user equipment 100 and may process the MEV blended frame using the residual matrices to output the denoised image at block 614. In this example, the weights of the denoising AI model may remain as is.

According to the present disclosure, the training module 222 may be adapted to train the denoising AI model to use the residual matrices. In order to train the AI denoising model, the training module 222 may receive a training dataset comprising a plurality of training MEV blended frames. In addition, the training dataset may include, for each of the plurality of MEV blended frames, a set of training residual matrices having previously identified pixels that have the noise. The training dataset may be provided by the training module 222 to the denoising AI model and accordingly, the training module 222 trains the AI denoising model. In one example, the training module 222 may provide the training dataset of over thousands of MEV blended frames.

The denoising AI model may denoise the MEV blended frame using static AI denoising weights. According to the present disclosure, the system 102 may operate in the second mode, i.e., the denoising AI model may denoise the MEV blended frame usage modified AI denoising weights. The exemplary sequence flow 900 will now be explained.

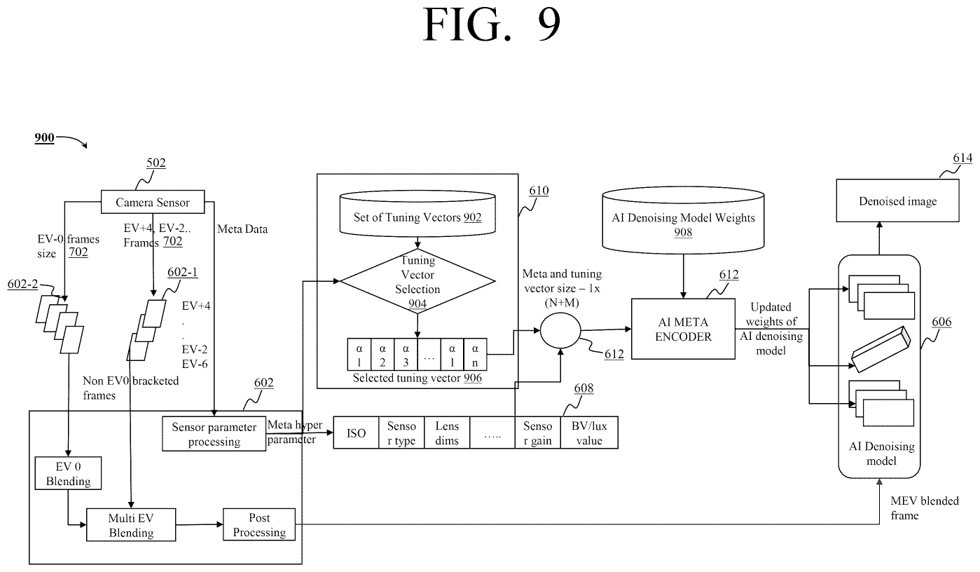

FIG. 9 illustrates a sequence flow 900 for denoising the image using the denoising AI model based on tuning vectors, in accordance with an embodiment of the present disclosure. The second sequence flow 900 begins at block 602 at which the image processing module 210 generates the MEV blended frame in a manner explained above and hence not repeated here for the sake of brevity. The image processing module 210 may also process the metadata and convert the same into a plurality of parameters. Further, the image processing module 210 may communicate the plurality of parameters to the hyper parameter generation module 212 that may generate the first hyper parameters 608 for each of the plurality of image frames 602.

In one example, the list of hyper parameters may include, but is not limited to,

ISO—Value ranging from 1 to ˜9000 and define/quantify the sensitivity of the camera sensor.

Camera sensor type—Ultra Wide, Tele, Wide

Lens dimensions—height and width and lens data gain

Sensor gain—Defines amplification of intensity of pixels which will be used to differentiate between training dataset values and inference image values

An exemplary set of first hyper parameters in accordance with the sequence provided above may be:
[256, wide, . . . 4, −100]
[830, wide, . . . 6, −256]
[6900, wide, . . . 2, −460]
[300, wide, . . . 2, −100]

The tuning vector selection module 214 may select a tuning vector from a set of tuning vectors at block 610. The tuning vector is a floating-point number chosen differently for a set of hyper-parameters and may allow in-place modification or tuning of the AI denoising model. The tuning vector is a tool designed to modify pre-trained neural networks and may function like a control mechanism, allowing for adjustment of the network's weights based on contextual information. According to the present disclosure, a tuning vector is manually selected based on the number of second hyper parameters provided in the dataset during the training. For example, if two datasets of camera sensor type, i.e., wide sensor and Ultra Wide (UW) sensor a tuning vector of cardinality 2 with specific values to be ‘00’ and ‘11’ may be selected. Further, the set of tuning vectors shown by block 902 is a static hash table that maps the tuning vectors and corresponding set of hyper-parameters which denote different sets of data.

The tuning vector selection module 214 may determine a distance between the generated plurality of second hyper parameters associated with each of the plurality of tuning vectors and the plurality of first. In one example, the distance is a Euclidean vector distance and the tuning vector selection module 214 may determine the distance to identify the first hyper parameter closest to any of the generated plurality of second hyper parameter and the corresponding tuning vector is selected. The selected tuning vector is concatenated to the plurality of first hyper parameters. An exemplary method is explained below:

In an embodiment, when three sets of tuning vectors (both in normalized and embedded form) are obtained from training:
Normalized: tuning vector “00”: [260, wide, 5, −100]
Embedding: tuning vector “00”: [0.2, 0.1, 0.2, 0.05]
Normalized: tuning vector “01”: [1000, wide, 4, −200]
Embedding: tuning vector “01”: [0.5, 0.1, 0.19, 0.010]
Normalized: tuning vector “11”: [4600, wide, 5, −600]
Embedding tuning vector “11”: [0.85, 0.1, 0.2, 0.005]
Let an input image frame 602 may have the following first hyper parameters:
Normalized IN: [365, wide, 4, −90]
Embedding IN: [0.25, 0.1, 0.19, 0.055]

The tuning vector selection module 214 may calculate the following vector distances:
IN-V1˜=0.0025
IN-V2˜=0.00625
IN-V3˜=0.035

The tuning vector selection module 214 determines that the minimum distance is V1 and accordingly, the tuning vector ‘00’ at block 904 is selected and concatenated with the first hyper parameter at block 906 to form the following string below:
[0.25, 0.1, 0.19, 0.055, 00]

Thereafter, the AI encoder module 216 may receive the concatenated string and AI denoising weights 908 at block 612. The AI encoder module 216, depending on the first hyper parameter and the tuning vector may determine whether to modify a single AI denoising weight or a plurality of AI denoising weights. In one example, the AI encoder module 216 may provide to a Distributed Neural network (DNN) the AI model denoising weights and concatenated first hyper parameters. The AI encoder module 216 may provide the modified AI denoising weights as output which are applied to the AI denoising model.

The AI encoder module 216 may communicate the modified AI denoising weights to the denoising AI model that may now use the modified AI denoising weight to denoise the MEV blended frame. Since the AI denoising weight(s) are modified using the first hyper parameters associated with the MEV blended frame, the denoising AI model may be able to better denoise the MEV blended frame.

According to the present disclosure, the system 102 may operate in the third mode in which the system 102 uses both the tuning vectors and residual matrices to denoise the MEV blended frame. In such an embodiment, the blocks 602 and 604 from the first sequence flow 600 are executed simultaneously to blocks 602, 608, 610, and 612 from the second sequence flow 900. Thereafter, the denoising AI model may receive the residual matrices indicating the pixel level information of the MEV blended frame and the modified AI denoising weights that are modified based on the first hyper parameters of the MEV blended frame. Upon the receipt of the residual matrices and the modified AI denoising weights, the denoising AI model may denoise the image at block 614.

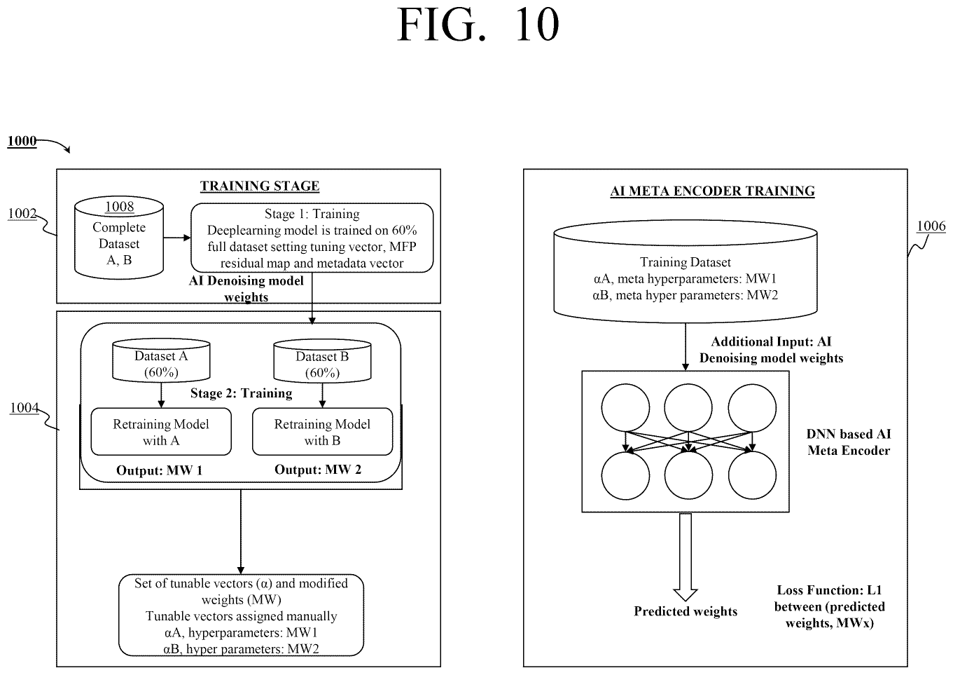

As mentioned before, the set of tuning vectors and the modified AI denoising weights are obtained by trained AI models. The manner by which the AI models are trained is explained with respect to FIG. 10.

FIG. 10 illustrates a training process flow 1000 for training the denoising AI model with the tuning vectors, in accordance with an embodiment of the present disclosure. The training process flow 1000 may involve training the AI models in series. At block 1002, a first level of training may be performed whereas at block 1004, a second level of training may be performed. Further, at block 1006, a third level of training may be performed using the output of the first block 1002 and the second block 1004.

At block 1002, a training dataset 1008 may be prepared. The training dataset may be prepared by capturing a plurality of images of a scene with ideal conditions (ISO 50 and good ambient lighting in the scene). The image with ideal conditions is termed as ground truth. The Ground truth is known as a target for training or validating the AI denoising model. In this context, the ground truth is an image frame that does not include any noise. Once the ground truth image is taken, the image-capturing device 104 may be actuated by the training module 222 to capture a plurality of images varying ISO images ranging from 50 to 7000 depending on the ambient light. The images with varying ISO may be provided as noisy image frames of the same scene. Thereafter, the image processing module 210 may pair each noisy image with the corresponding ISO 50 image to form the plurality of training MEV blended frames. Additionally, the training module 222 may also store the first hyper parameters provided by the hyper parameter generation module 212 for each of the plurality of MEV blended frames.

By following the aforementioned approach, the training module 222 may ensure that the dataset includes both perfect image frames with well-lit scenes as well as noisy image frames with varying ISO levels, to allow accurate assessment of the performance of the denoising algorithm across different lighting conditions.

The training module 222 may train the denoising AI model. In one example, the training module 222 may train a first AI model by all the available ISOs. In one example, the first AI model is the AI denoising model. Further, as part of the training, the training module 222 may determine different kinds of known weightage losses, such as Mean Absolute Error (MAE) also known as L1 loss, Structural Similarity (SSIM) Index, and perceptual loss, etc. The training of the denoising AI model at block 1008 results in the generation of the denoising AI model and the losses. The denoising AI model weight generated at block 1008 is termed Base Weight (BW).

At block 1004, the training module 222 may now divide the plurality of MEV blended frames having a known second hyper parameter based on the known parameters. For example, the training module 222 may divide the plurality of MEV blended frames based on the associated ISO values. For instance, the training module 222 may divide the dataset into three sets based on ISO as the second hyper parameters in the following categories: ISO_LOW (values from 50-700), ISO_MEDIUM (values from 700-3000), ISO_HIGH (values above 3000). Thereafter, the training module 222 may initialize a set of binary numbered Tuneable vectors of the same number as the subset i.e., three sets ISO_LOW—‘00’, ISO_MEDIUM—‘01’, ISO_HIGH—‘11’

Once the initial tuning vectors are assigned, the training module 222 may train three separate models with the same architecture using the respective ISO sets. In one example, each of these separate models is termed the second AI model.

Further, the training module 222 may initialize the weights for all three AI models with the BW and accordingly, the training module 222 may select a variation in the weights of losses according to the ISO range as:

For ISO_LOW “L1” is given maximum weightage (50%), SSIM (25%), perceptual loss (25%)

For ISO_MEDIUM all the losses are given similar weightage L1 (33%), SSIM (33%), perceptual loss (33%)

For ISO_HIGH-Perceptual losses are given the most weightage (50%), L1 −25%, SSIM-25%

By selecting the aforementioned variation, the three AI models may produce the modified weights MW1, MW2, and MW3. Thereafter, the training module 22 may generate the set of tuning vectors for each model as MW1-‘00’, MW2-‘01’, and MW3-‘11’.

At block 1006, the training module 222 may now train the AI encoder module 216. The training module 222 may begin with creating another dataset. The training module 222 may create training pairs by mapping each image's hyperparameter to the corresponding modified weight MW1. For instance, the training module 222 may map the hyperparameters of each image within each ISO group to the corresponding modified weight (MW1). For example, an image frame 1 with second hyper parameter ISO 256 is mapped to MW1. Since the MW1 is mapped to the second hyper parameter which is the basis for training the AI encoder module 216, the MW1 now becomes the ground truth for the second hyper parameter of image frame 1.

Accordingly, the training module 222 may create the following dataset for the second hyper parameter In accordance with the sequence [ISO, sensor, . . . sensor gain, BV]:
Image 1 hyper [256, wide, . . . 4, −100]+Tuneable “00”−GT→MW1
Image 2 hyper [830, wide, . . . 6, −256]+Tuneable “01”−GT→MW2
Image 3 hyper [6800, wide, . . . 2, −450]+Tuneable “11”−GT→MW3 . . .

An exemplary mapping is also shown below.

| Image | | |
|---|---|---|
| frame | Input second hyper parameter | Ground truth |
| 1 | [256, wide, . . . 4, − 100] + | MW1 = {w1: [0.3, 0.6, 0.4], |
| | Tuneable “00” | w2: [0.009, 0.05] . . . } |
| 2 | [830, wide, . . . 6, −256] + | MW2 = {w1: [0.23, 0.66, 0.42], |
| | Tuneable “01” | w2: [0.008, 0.04] . . . } |
| 3 | [6800, wide, . . . 2, −450] + | MW3 = {w1: [0.26, 0.64, 0.32], |
| | Tuneable “11” | w2: [0.010, 0.03] . . . } |
| 4 | [300, wide, . . . 2, −100] + | MW1 = {w1: [0.3, 0.6, 0.4], |
| | Tuneable “00” | w2: [0.009, 0.05] . . . } |

In addition to the second hyper parameters, the training module 222 may provide the BW obtained from block 1002 to the AI encoder module 216. Once the receipt of the mapped hyperparameters and the BW, the training module 222 may train the AI encoder module 216. The AI encoder module 216 may be a Deep Neural Network (DNN) with the input being the hyperparameters concatenated with the corresponding tuning parameter from block 1004. Once trained, the training module 222 may test the trained DNN by providing one or more inference image frames and associated second hyper parameters to the model to allow the denoising AI model to predict the modified AI denoising weights. Further, the training module 222 may compare the prediction with the corresponding modified weight using the L1 loss between the prediction and MWx for optimization. The comparison may include determining a difference between the numerical values of the modified AI denoising weights. An exemplary difference is provided below:
D1=|Inference image 1−ground truth|
D2=|Inference image 2−ground truth|
D=|Reference image−ground truth|

The DNN model may predict an optimal AI denoising weight. Once the training

module 222 determines that the differences D1 and D2 are closer to D, the training module 222 infers that the AI encoder module 216 is trained and ready for deployment.

According to the present disclosure, the training module 222 may train the denoising AI model in case the residual matrices are employed. As a part of the training, the training module 222 may create a dataset containing noisy images, exposure residual maps, and ground truth images. In order to create the dataset, the training module 222 may actuate the image-capturing device to capture two images for each scene: one with ideal scene hyperparameters (good lighting, ISO 50, specific lens) as the ground truth (GT), and another set of noisy images with varying conditions (low light, bright light, normal light) and a range of ISO values. Further, the training module 222 may actuate the image processing module 210 to generate MEV blended frame in the manner explained above. In addition, the training module 222 may receive an exposure residue matrix (or exposure matrix) corresponding to the noisy images. Finally, the training module 222 may combine the noisy image pairs and respective exposure values to form the input image frames.

Thereafter, the training module 222 may train the denoising AI model by combining the noisy image and exposure residue as a single concatenated input. In addition, the training module 222 may calculate L1, SSIM, and Perceptual Loss between the predicted result and the ground truth. This process is implemented for all the image pairs to train the AI denoising model.

According to the present disclosure, in case the system 102 is configured to operate in the third mode, the training module 222 may train the aforementioned first AI model, the second AI model, the AI encoder module 216, and the denoising AI model using both the MEV blended frame and residual maps. The manner by which the training is performed is explained above and hence not repeated for the sake of brevity.

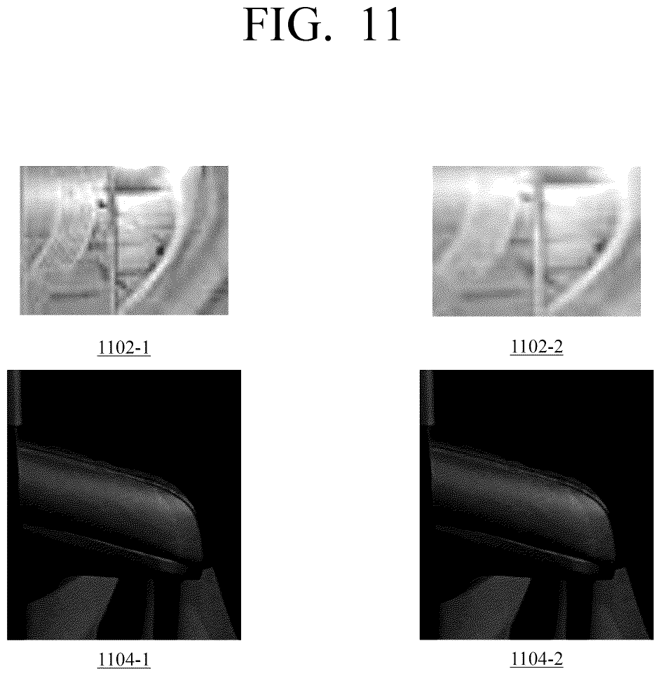

FIG. 11 illustrates exemplary image frames prior and after the denoising, in accordance with an embodiment of the present disclosure. Image 1102-1 illustrates the noise in the form of a green artefact which is removed in the image ¬-2 when the system 102 operates in the first mode. Similarly, image 1104-1 illustrates the noise in the form of a grainy dark region which is removed in the image 1104-2 when the system 102 operates in the second mode.

Accordingly, the present disclosure helps in achieving the following advantages:

Better and quicker denoising of the captured images.

Denoising is performed without creating undue load on the processing resource of the UE 100.

Versatility in operating in different modes based on potential hardware limitations of the UE 100.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

While at least one exemplary embodiment has been presented in the foregoing detailed description, it should be appreciated that a vast number of variations exist.

What is claimed is:

1. A controlling method of an electronic apparatus for denoising a plurality of input images, the method comprising:
obtaining a Multi-Exposure Value (MEV) blended frame based on the plurality of input images, wherein each of the plurality of input images comprise an Exposure Value (EV);
obtaining a plurality of first hyper parameters associated with a plurality of parameters associated with each of the plurality of input images;
identifying a tuning vector among a plurality of tuning vectors based on a distance between a plurality of second hyper parameters that are associated with each of the plurality of tuning vectors and the plurality of first hyper parameters;
modifying at least one weight of a denoising Artificial Intelligence (AI) model based on the tuning vector and the plurality of first hyper parameters using an encoder AI model; and
denoising the MEV blended frame using the denoising AI model having the at least one modified weight.

2. The method of claim 1, further comprising:
prior to the denoising the MEV blended frame, modifying at least one layer of the denoising AI model using the at least one modified weight.

3. The method of claim 1, further comprising:
receiving a dataset of training MEV blended frames, wherein the dataset of training MEV blended frames comprises one or more MEV blended frames with a hyper parameter; and
training a first AI model using the dataset of training MEV blended frames to obtain a plurality of denoising AI model weights.

4. The method of claim 3, further comprising:
training, for the one or more MEV blended frames with the hyper parameter, a second AI denoising model; and
obtaining a set of tuning vectors and a plurality of modified denoising AI model weights based on the training.

5. The method of claim 4, further comprising:
training the encoder AI model using the dataset of training MEV blended frames, the set of tuning vectors, and the plurality of denoising AI model weights.

6. The method of claim 1, wherein the obtaining the MEV blended frame comprises:
receiving, from an image capturing device, the plurality of input images and the plurality of parameters;
obtaining at least one reference frame among the plurality of input images;
blending the plurality of input frames based on the at least one reference frame; and
obtaining the MEV blended frame based on the blending.

7. The method of claim 6, wherein the at least one reference frame has an EV equal to zero.

8. The method of claim 6, further comprising:
obtaining one or more residual matrices based on correlating each of one or more regions of the MEV blended frame with the plurality of input images, wherein the one or more residual matrices correspond to at least one of an exposure map, a radial distance map, and a motion map; and
denoising the MEV blended frame based on the one or more residual matrices and the plurality of parameters using the denoising AI model.

9. The method of claim 8, wherein the obtaining the one or more residual matrices comprises:
obtaining the radial distance map having one or more radial values associated with the one or more regions of the MEV blended frame, wherein the one or more radial values define a distance of each region among the one or more regions from a focused area in the MEV blended frame; or
obtaining the motion map having one or more motion values associated with each of the one or more regions to depict a motion in the MEV blended frame.

10. The method of claim 1, wherein the plurality of parameters include one or more of a brightness value, ISO sensitivity information, white balance, color correction matrix, sensor gain, and zoom ratio.

11. An electronic apparatus for denoising a plurality of input images, comprises:
a memory, and
at least one processor in communication with the memory, wherein the at least one processor is configured to:
obtain a Multi-Exposure Value (MEV) blended frame based on a plurality of input images, wherein each of the plurality of input images comprise an Exposure Value (EV),
obtain a plurality of first hyper parameters associated with a plurality of parameters associated with each of the plurality of input images,
identify a tuning vector among a plurality of tuning vectors based on a distance between the plurality of first hyper parameters and a plurality of second hyper parameters that are associated with each of the plurality of tuning vectors,
modify at least one weight of a denoising Artificial Intelligence (AI) model based on the tuning vector and the plurality of first hyper parameters using an encoder AI model, and
denoise the MEV blended frame using the denoising AI model having the at least one modified weight.

12. The electronic apparatus of claim 11, wherein the at least one processor further configured to:
prior to denoising the MEV blended frame, modify at least one layer of the denoising AI model using the at least one modified weight.

13. The electronic apparatus of claim 11, wherein the at least one processor further configured to:
receive a dataset of training MEV blended frames, wherein the dataset of training MEV blended frames comprises one or more MEV blended frames with a hyper parameter, and
train a first AI model using the dataset of training MEV blended frames to obtain a plurality of denoise AI model weights.

14. The electronic apparatus of claim 13, wherein the at least one processor further configured to:
train, for the one or more MEV blended frames with the hyper parameter, a second AI denoise model, and
obtain a set of tuning vectors and a plurality of modified denoise AI model weights based on the training.

15. The electronic apparatus of claim 14, wherein the at least one processor further configured to:
train the encoder AI model using the dataset of training MEV blended frames, the set of tuning vectors, and the plurality of denoise AI model weights.

16. A non-transitory computer readable medium storing one or more instructions that, when executed by at least one processor, cause the at least on processor to:
obtain a Multi-Exposure Value (MEV) blended frame based on a plurality of input images, wherein each of the plurality of input images comprise an Exposure Value (EV);
obtain a plurality of first hyper parameters associated with a plurality of parameters associated with each of the plurality of input images;
identify a tuning vector among a plurality of tuning vectors based on a distance between a plurality of second hyper parameters that are associated with each of the plurality of tuning vectors and the plurality of first hyper parameters;
modify at least one weight of a denoising Artificial Intelligence (AI) model based on the tuning vector and the plurality of first hyper parameters using an encoder AI model; and
denoise the MEV blended frame using the denoising AI model having the at least one modified weight.

17. The non-transitory computer readable medium of claim 16, wherein the one or more instructions further cause the at least one processor to, prior to the denoising the MEV blended frame, modify at least one layer of the denoising AI model using the at least one modified weight.

18. The non-transitory computer readable medium of claim 16, wherein the one or more instructions further cause the at least one processor to:
receive a dataset of training MEV blended frames, wherein the dataset of training MEV blended frames comprises one or more MEV blended frames with a hyper parameter; and
train a first AI model using the dataset of training MEV blended frames to obtain a plurality of denoising AI model weights.

19. The non-transitory computer readable medium of claim 18, wherein the one or more instructions further cause the at least one processor to:
train, for the one or more MEV blended frames with the hyper parameter, a second AI denoising model; and
obtain a set of tuning vectors and a plurality of modified denoising AI model weights based on the training.

20. The non-transitory computer readable medium of claim 19, wherein the one or more instructions further cause the at least one processor to train the encoder AI model using the dataset of training MEV blended frames, the set of tuning vectors, and the plurality of denoising AI model weights.
